(19) United States
(12) Patent Application Publication
(10) Pub. No.: US 2011/0022250 A1
(43) Pub. Date: Jan. 27, 2011

(54) Helicopter autopilot

(76) Inventor: Ron Wayne Hamburg, Sacramento, CA (US)

Correspondence Address: RON WAYNE HAMBURG, 5518 DATE AVENUE, SACRAMENTO, CA, 95842, US

(21) Appl. No.: 12/288,561

(22) Filed: Oct. 21, 2008

(51) Int. Cl. G05D 1/00; G01C 21/00; G01S 1/02

(52) U.S. Cl. 701/11

(57) ABSTRACT

The Helicopter Autopilot operates by recording GPS (Global Positioning System) and/or accellerometer coordinates on CD-ROM during a programming flight or maneuver. To autopilot this flight plan, the received GPS coordinates that show the pilot's real-time position, will be compared with the programmed GPS coordinates that represent the magnetic course high-lighted on the dashboard GPS terrain map display screen. The flight controls are computor adjusted until the helicopter is aligned with this pre-recorded magnetic course shown on the GPS display screen. The altitude, latitude, longitude and velocity are matched to these timed programmed coordinates. The automatic flight controls of the cyclic (main rotor tilt), the collective pitch (main rotor blades angle of attack), the anti-torque pedals (tail rotor blades angle of attack), and the throttle (engine power and RPM), which will change the yaw, pitch, roll and airspeed to again fly the helicopter through this pre-recorded GPS coordinate sequence.

### CROSS-REFERENCE TO RELATED APPLICATIONS

“Not Applicable”

### REFERENCE TO SEQUENCE LISTING

“Not Applicable”

### BACKGROUND OF THE INVENTION

The Helicopter Autopilot system can autopilot helicopter flight controls using GPS (Global Positioning System) coordinates, accellerometer coordinates and VOR (VHF Omnidirectional Range) radio signals. VOR and the Victor airways is primarily used by autopilot systems in today's aircraft.

The Helicopter Autopilot will comprise of a GPS receiver installed in the front of the helicopter and will be continually receiving GPS coordinate data. One method of operating the autopilot is to fly a flight plan and record these received GPS coordinates on CD-ROM using the onboard computor and GPS terrain map display screen. The autopilot can then be used to fly an identical autopilot flight. This is accomplished by computor controlling cyclic, collective pitch, anti-torque and throttle to match the real-time GPS coordinates with the pre-recorded programmed coordinates. The GPS display screen will show a high-lighted pre-recorded magnetic course and the helicopter image showing the pilot's position will be directed to pass through the programmed GPS coordinates.

### SUMMARY OF THE INVENTION

In summary the operation of the Helicopter Autopilot system can be described in this way: Once the helicopter has been fitted with the combination of GPS receiver, VOR, magnetic compass, accellerometers, microprocessors, servo motors, GPS horizon display screen and GPS terrain map display screen, this onboard computor is designed to record received GPS coordinates on CD-ROM and autopilot the helicopter. While flying the programming flight, GPS coordinates that the helicopter passes through are recorded every four (4) to thirty (30) seconds of flight. This sequence of GPS coordinates, from take-off to landing, represents the altitude, latitude, longitude and velocity of the helicopter as it is flown through this flight plan. To fly this flight plan again, using the autopilot, the CD-ROM is engaged and the pre-recorded GPS coordinates appear on the dashboard GPS display screen as a high-lighted magnetic course.

The Helicopter Autopilot will compare received real-time GPS coordinates, which show the pilot's real-time position at any time on this same GPS display screen, with the pre-recorded GPS coordinates. Automatic flight control adjustments of the cyclic, collective pitch, anti-torque and throttle will be made to align and match the real-time GPS coordinates with the pre-recorded GPS coordinates. This will result in an identical autopiloted flight.

To autopilot a maneuver such as circling or hovering, the GPS coordinates are recorded during this maneuver and system is engaged to continue circling or hovering. Accellerometers measuring triaxial accellerations are used to monitor flight control adjustments.

A Standard Flight Plan Profile can be used to autopilot helicopter to a heliport identified by a GPS coordinate input into the GPS terrain map data base. The Hemispherical Cruising Rule is observed, and ascent and descent is controlled. A pre-recorded flight is not necessary.

### BRIEF DESCRIPTION OF SEVERAL VIEWS OF THE DRAWINGS

Here in these drawings, the Helicopter Autopilot is depicted. The drawings show a helicopter autopiloted during a flight to a destination identified by, a GPS coordinate. A Standard Flight Plan Profile is used and a prior programming flight is not required.

A block diagram schematic of the helicopter autopilot system with incoming navigational data passing through microprocessors that show the real-time position on the GPS display screen and flight control adjustments will be determined at the GPS display screen to match the real-time coordinates with the pre-recorded coordinates.

A helicopter hovering is shown where the autopilot can be used to hold this position once the GPS coordinates are recorded on CD-ROM and autopilot is engaged.

FIG. 1 is a Standard Flight Plan Profile. The drawing shows: (1) helicopter take-off, (2) ascent, (3) to level flight, (4) Approximately one-thousand feet (1000 FT.) from destination, (5) helicopter descent, (6) landing at GPS coordinates.

FIG. 2 is a Helicopter Autopilot system block diagram schematic. The drawing shows: (1) GPS receiver, (2) magnetic compass, (3) VOR, (4) accellerometers, (5) PCI atomic clock, (6) microprocessors or CPU's, (7) GPS Horizon display screen, (8) CD-ROM, (9) GPS terrain display screen, (10) Cockpit flight controls, (11) microprocessors controlling range of adjustment, (12) servo, (13) mechanical systems.

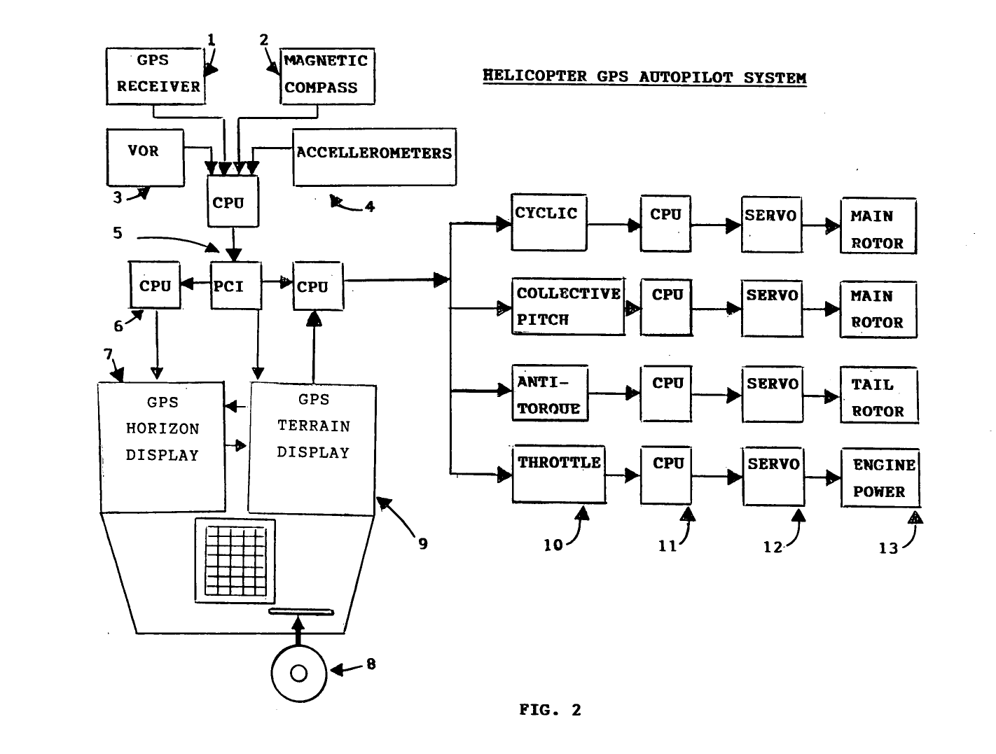

FIG. 3 is a helicopter hovering using autopilot flight control. The drawing shows: (1) the received GPS radio signals from the orbiting satellites, (2) autopiloted helicopter, (3) GPS receiver installed in helicopter, (4) Lifting line, (5) cable hook.

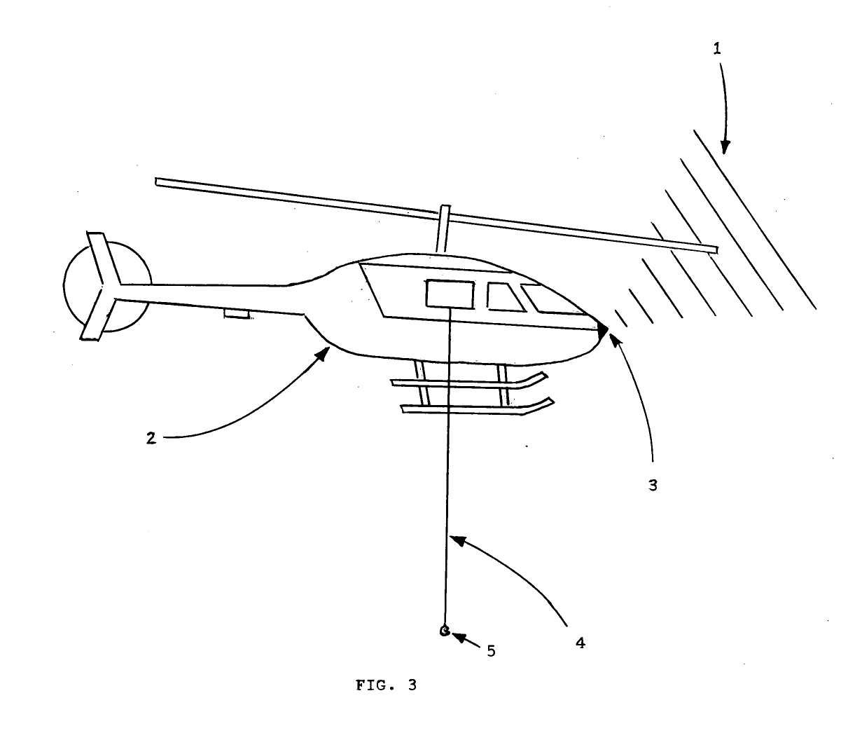

### DETAILED DESCRIPTION OF THE INVENTION

The Helicopter Autopilot can be described as a navigational aid for helicopters, that can also automatically make flight control adjustments for yaw, pitch, roll and airspeed changes, while aligning the helicopter to a pre-recorded GPS coordinate course and altitude sequence. The pre-recorded GPS coordinates are stored on CD-ROM during a programming flight and then are made available to the onboard computor when this flight plan is autopiloted. The helicopter's real-time GPS coordinates will show a helicopter image on the GPS display screen. This is the pilot's position with reference to terrain and latitude and longitude. The pre-recorded GPS coordinates will be high-lighted on this same display screen and represents the magnetic course flown. Using this display screen for alignment, main rotor tilt (cyclic) and tail rotor (anti-torque) adjustments will be automatically made by onboard computor as the helicopter's real-time GPS coordinates are matched with the pre-recorded GPS coordinates. The main rotor collective pitch control and throttle will be computor controlled and adjustments made to match the altitude and velocity of these same pre-recorded GPS coordinates. An identical helicopter flight plan is the result obtained with this autopilot system. Several flight plans to various destinations can be flown and stored on CD-ROM in this way and engaged to autopilot the helicopter.

Three (3) methods of operation can be used with this autopilot.

1.) Fly and record an entire flight, and then fly an identical autopiloted flight.

2.) Fly and record a maneuver such as circling or hovering and engage autopilot to continue flying maneuver at any time during a flight.

3.) Input GPS coordinates of destination into GPS data base and fly to destination using a Standard Flight Plan Pro-file.

1. The invention claimed is: A Helicopter Autopilot system comprising of a GPS receiver, a magnetic compass, VOR, accellerometers, PCI atomic clock(s), four (4) to ten (10) microprocessors, four (4) servo motors or directly wired to existing motors, dashboard GPS display screen(s) functioning as an onboard computor that automatically adjusts the flight controls of the cyclic, collective pitch, anti-torque pedals and throttle to control yaw, pitch, roll and airspeed of the helicopter while flying through and matching real-time GPS coordinates to pre-recorded GPS coordinates that represent a magnetic course shown on the GPS display screen.

2. The invention claimed is: A Helicopter Autopilot system and process comprising of autopiloting a helicopter using the procedure of flying a flight plan or maneuver and recording said GPS coordinates that the helicopter has flown through, as determined by the onboard GPS receiver and/or accellerometers and stored on CD-ROM at four (4) to (30) second intervals. The process is to include the recording of several flights on CD-ROM and then used in an autopilot system as described.)

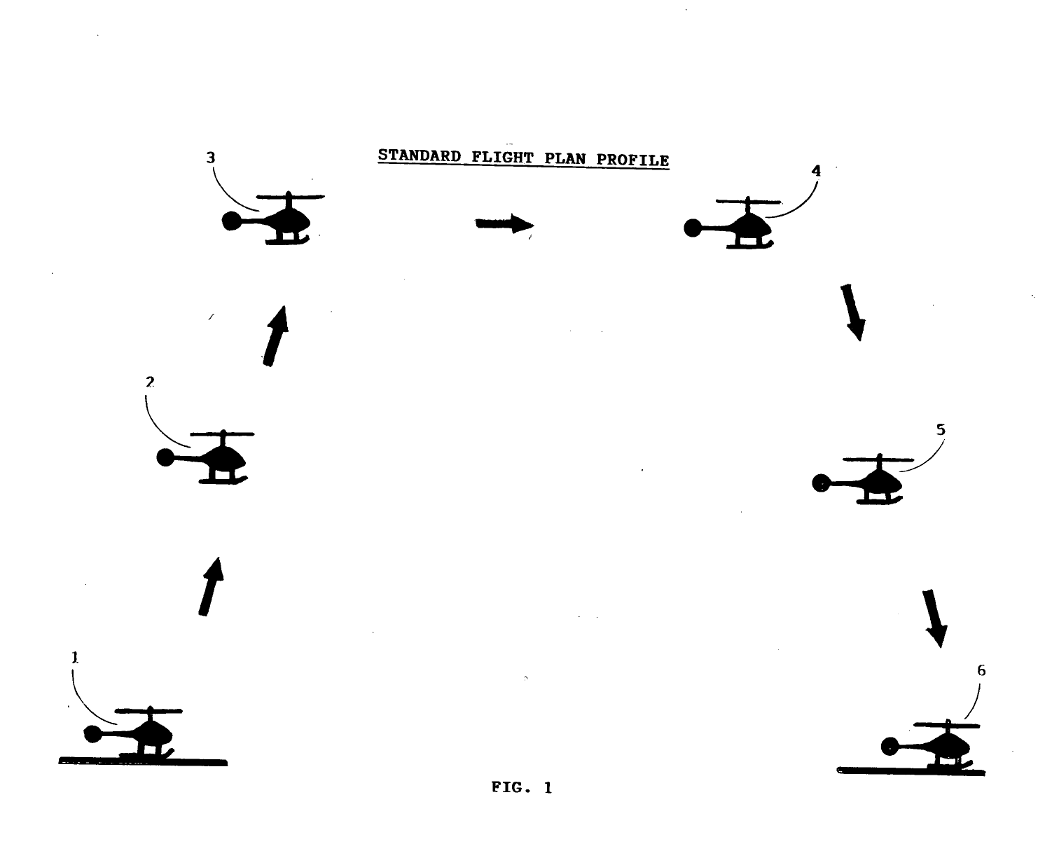

3. The invention claimed is: A Helicopter Autopilot system that utilizes a “Standard Flight Plan Profile” while autopiloting a helicopter to a GPS coordinate that has been input into the onboard computor data base and that identifies a landing location that is shown on the dashboard GPS terrain map display screen, this is depicted in FIG. 1 of the drawings.
